(19) United States
(12) Patent Application Publication
(10) Pub. No.: US 2011/0293389 A1
(43) Pub. Date: Dec. 1, 2011

(54) METHOD AND SYSTEM FOR PRODUCING A PRINTED PRODUCT

(75) Inventor: Guenther Silberbauer, Uerkheim (CH)

(73) Assignee: Mueller Martini Holding AG, Hergiswil (CH)

(21) Appl. No.: 13/116,604

(22) Filed: May 26, 2011

(30) Foreign Application Priority Data
May 26, 2010 (CH) 00827/10

(51) Int. Cl. B42C 9/00

(52) U.S. Cl. 412/1; 412/9

(57) ABSTRACT

A method and system for producing a printed product are provided. The method includes conveying signatures along a first conveying section, conveying inserts along a second conveying section, supplying the signatures to at least one of a first gathering location and a second gathering location, supplying the inserts to at least the second gathering location, forming a partial book block in at least one of the first gathering location and the second gathering location, wherein the partial book block comprises the supplied signatures and, optionally, at least one of the supplied inserts, and supplying the partial book block to a further gathering location to form a stacked book block.

### CROSS-REFERENCE TO RELATED APPLICATION

This application claims the priority benefit of Swiss Patent Application No. 00827/10, filed on May 26, 2010, the subject matter of which is hereby incorporated by reference in its entirety.

### BACKGROUND

1. Field of Invention

The invention relates to a method and system for producing a printed product.

2. Related Art

A method for producing printed products such as books, booklets, magazines or the like is known from the document EP 1 559 573 A1. According to this method, the signatures or sheets printed in a printing press are respectively folded in a folding device, are then conveyed to a stacking device and are stacked therein to form a book block. At least one insert or extra sheet is added to an individual signature and the combined product of signature and insert, which forms a unit, is then conveyed further and stacked. The insert is thus added to an individual signature and the product composed of signature and insert is subsequently stacked in the same general manner as other signatures or printed sheets to form a book block. The aforementioned inserts or extra sheets can involve illustrations, colored pictures or they can refer to printed sheets composed of a special type of paper. The inserts can furthermore be functional sheets which are effectively inserted during a post-processing operation, such as the fly leaves for hardcover books. The book block provided with the insert can then be processed in the standard manner, for example through adhesive binding, trimming, and the like, wherein several inserts can also be placed without a problem into the book block. EP 1 559 573 A1 furthermore discloses that the insert can be pulled with the aid of a feeder from a stack and can subsequently be added to the individual signature. It is furthermore possible to guide the insert to a second conveying device where it is combined with an individual signature that is conveyed sequentially in a conveying device. The second conveying device in this case is preferably supplied with the aid of a feeder, wherein several feeders that respectively deliver one insert to this second conveying device must be used if several different inserts are to be made available. A book block can thus be formed which comprises several different inserts, wherein these inserts can furthermore be inserted at different locations into the book block. However, each insert is always added to a single signature.

However, if the inserts are to be added at irregular intervals and not in the same sequence during the forming of the book blocks, or if several inserts must follow successively, or if the inserts are embodied at least in part as signatures, the systems known from the prior art reach their operational limits with respect to position accuracy and output rate. To be sure, improvements in some points are possible, but these improvements always involve a relatively large expenditure.

### SUMMARY

In a product flow of signatures, using a method of the aforementioned type, embodiments of the invention make it possible, for example, to continuously supply differently embodied inserts as needed or in a clocked manner, such that intermediate partial book blocks are formed which are then consistently stacked one above the other to form a complete book block.

According to an embodiment of the invention, a method and system for producing a printed product are provided. The method includes conveying signatures along a first conveying section, conveying inserts along a second conveying section, supplying the signatures to at least one of a first gathering location and a second gathering location, supplying the inserts to at least the second gathering location, forming a partial book block in at least one of the first gathering location and the second gathering location, wherein the partial book block comprises the supplied signatures and, optionally, at least one of the supplied inserts, and supplying the partial book block to a further gathering location to form a stacked book block.

According to an embodiment of the invention, a method and system is provided for producing a printed product for which the printed product itself or at least a partial product thereof is composed of at least one signature and/or at least one insert. The signature and the insert are gathered partially or integrally in a conveying system and are subsequently conveyed to a gathering location where the actual final stacking for forming a complete book block takes place. The conveying system itself may include a first, and preferably horizontal, conveying section, functioning as a first conveying plane, in which the signatures are also gathered and conveyed to form individual partial book blocks. Following the temporary storage in a first gathering location, at least one partial book block is transferred to a second gathering location, preferably arranged lower, which for the operation is directly connected to a different conveying section for inserts. Partial products are formed in this second gathering section, which products consist of an optional combination of individual and/or composite signatures supplied by the first conveying section and/or inserts supplied by the additional conveying section. A partial product of this type is then moved to a third gathering plane, preferably arranged vertically underneath, in which the partial book blocks are joined to form a complete book block. However, the method can conceivably also be realized with two gathering planes, such that the book block is conveyed further in the same plane following the completion.

The method consequently can be understood to operate in some embodiments such that with at least two, preferably three, vertically or quasi-vertically (or horizontally or quasi-horizontally) arranged planes, partial book blocks and/or finished book blocks are created and stacked in such a way that the inserts are placed into predetermined intermediate spaces or gaps of the partial book blocks.

The first conveying section can contain planned locations for a division, wherein such a division offers itself if the flow of signatures is not composed of individual, spaced apart sheets or signatures, but takes the form of a scaled or overlapping flow. In that case, the division serves the purpose of using different conveying speeds for the flow to support the following separation in the stacking process by forming a gap, for example with the aid of intermittent separating elements. Hold-back elements for inserting a gap can furthermore also be used together with the scaled flow in the first conveying section, so as to support the separating out of a partial book block.

Hold-back elements of this type can be embodied as intermittently operating elements in the form of rakes which engage with precise timing in the scaled flow and which briefly delay the section of the scaled flow in which they engage, so that the section of the scaled flow that continues to be conveyed can supply the gathering device without problem. This mode of operation is known per se to one skilled in the art of stackers or so-called cross-stackers which operate, for example, downstream of a gathering and wire-stitching machine.

On the one hand, the method and system according to an embodiment of the invention is distinguished in that the individual gathering locations need not absolutely be arranged one above the other in a vertical direction, meaning they need not occupy different planes relative to each other. These locations can occupy any position, for example one behind the other, side-by-side or any position in the space.

On the other hand, the method and system according to an embodiment of the invention is distinguished in that the signatures or the partial book blocks composed of several signatures can bypass additional intermediary gathering locations and can be guided from the first conveying plane directly to the third or final gathering location in which these printed products are stacked to form a book block.

In addition, the signatures or the partial book blocks can be transferred alternately from the first conveying section to the second gathering location where they can be supplemented with inserts, or they can be transferred directly to the third gathering location while bypassing the conveying section for the inserts. The latter case applies, for example, if a book block should not contain inserts. The system can thus continuously be switched dynamically between book blocks provided with inserts and book blocks without inserts, thereby resulting in an economic, flexible and efficient design for the system.

The method and system according to an embodiment of the invention therefore involves the forming of feeding flow of signatures such as, for example, digitally sequentially printed signatures, wherein these essentially represent the content of a printed product. If a product is printed sequentially, it means that a digital printer starts with the first signature or sheet of the printed product and immediately adds the following signatures or sheets which are needed to complete the printed product. Digital printers operate without a fixed print form and can thus operate in the manner as described.

Since a scaled flow is not absolutely required for this mode of operation, individual signatures can also be processed without problem. These signatures are initially supplied to a stacking magazine or stacker, which is part of a stacking device, wherein the stacking magazine includes, for example, at least two conveying sections. In a first conveying section, the signatures are gathered into partial book blocks and are separated with the aid of suitable means such as separating elements. A separated-out partial book block may be conveyed further by dropping it from a first or second gathering plane, for example, through pulling back of the separating forks. If the gathering locations are not positioned one above the other, the partial book blocks can also be conveyed further with other conveying means. In this intermediate phase, the partial book block as a rule is provided with an insert which is supplied via a different conveying path and/or conveying section. However, inserts are not added in all cases to the individual signatures or partial book blocks, wherein the partial book blocks can in some cases be conveyed further without inserts. A different and lower positioned gathering plane may be used in which the partial book blocks and/or the partial book blocks provided with inserts are gathered and combined to form individual book blocks. The book blocks formed in this way are then supplied from the last-mentioned gathering plane to a further processing location such as, for example, to a perfect binder.

According to an embodiment of the invention, the inserts are not supplied to and/or integrated into the flow of signatures, but are conveyed with the aid of a separate conveying arrangement to the processing location, thus resulting in a simpler design per se of the overall system. As far as its functionality is concerned, the method according to the an embodiment of the invention makes it possible to achieve a highly visible targeted division of the functions along the individual conveying sections and/or the gathering locations, so that the system is characterized by high flexibility. Kinematic interventions in the conveying system during an increase or decrease of the cadence of the supplied printed products, regardless of whether the products are composed of individual signatures or partial book blocks, as well as during a changeover with respect to the composition of the book blocks to be formed, can all occur within the individual conveying sections, wherein the high flexibility is preserved.

The format changes can furthermore be realized as a result of the division into various gathering locations or conveying sections in that the partial book blocks are respectively delayed briefly.

A system configured in this way, therefore, has the advantage of permitting extremely high speeds for conveying the individual signatures, for forming the partial book blocks, as well as during the insertion operation, wherein these high speeds simultaneously also permit the online printing of the signatures conveyed in the flows, the partial book blocks, or the inserts.

According to an embodiment of the invention, the different conveying sections operate autonomously, meaning the interdependence of the individual sections, relative to each other, is limited to combining the partial printed products within the last gathering location, thereby resulting in further competitive productivity.

According to an embodiment of the invention, the signatures can be supplied either in a scaled flow or individually to the stacking location. As a result, the upstream folding of the signatures does not depend on the conveying speeds of the printed products within the individual conveying sections. That is to say, a scaled flow can easily be started and/or realized instantly as needed and with time restriction, making it unnecessary to intervene in the original cadence of the folding operations. Thus, the scaled formation can be considered and/or planned dynamically as a buffer conveying section with spaced-apart signatures.

According to another embodiment, the system can operate within the different planes without requiring standard auxiliary elements. For example, the system can operate without grippers mounted along the individual product flows.

In many cases, the signatures are created with the aid of a simple folding operation. However, it is also possible for the signatures to be folded multiple times. Folded signatures generally have a very high form stability which is advantageous for reliable and precise stacking.

Signatures which have multiple folds are generally trimmed after the final stacking to form a complete book block, wherein the excess folding edges are cut off during this operation. Of course, the inserts can also be folded with the aid of autonomous systems if necessary.

### BRIEF DESCRIPTION OF THE DRAWINGS

These and other features and advantages will be further understood from the following detailed description of an embodiment of the invention with reference to the accompanying drawing, in which:

FIG. 1 depicts a system and method for conveying at least one signature and/or at least one insert with the aid of different conveying planes, as well as a stacking operation, according to an embodiment of the invention.

### DETAILED DESCRIPTION

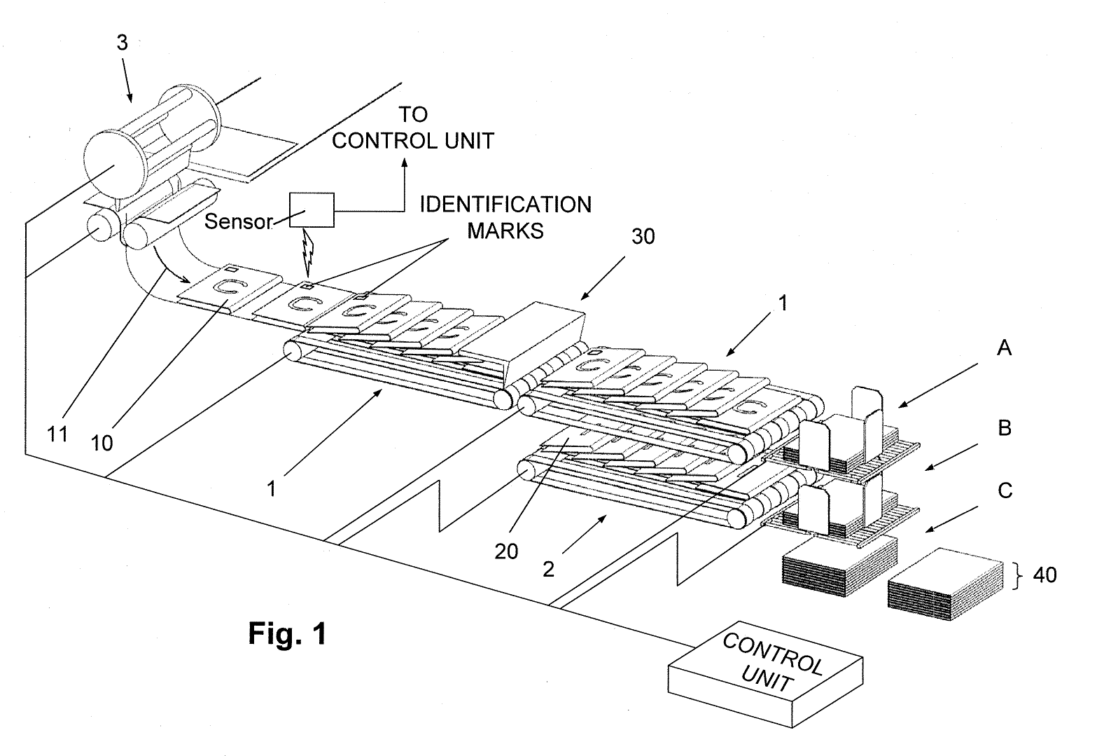

A conveying method and system for forming book blocks composed of individual signatures 10 and/or inserts 20 according an embodiment of the invention is shown in FIG. 1. The signatures 10 and the inserts 20 are gathered along the system and are subsequently transferred to a location for final stacking into a complete book block 40. The system includes a device in which individually cut, printed sheets are folded in lateral direction with the aid of a folding sword 3, so as to form the signatures 10. For this, a simple folding operation is carried out in such a way that a back fold of each signature 10 is facing forward in a conveying direction 11. The same is true for the inserts 20, insofar as these are also subjected to a folding operation (not shown).

Even without the folding operation, the inserts 20 must be positioned consistent with the signatures 10, so as to permit a uniform stacking.

With this system, which is respectively designed for at least one translatory movement in a horizontal direction, it is important to ensure that the folds are uniformly positioned in the conveying direction 11, thereby ensuring a uniform stacking of the printed products. The folded signatures 10 and the inserts 20 are respectively transported via separate conveying sections 1, 2. As shown in the embodiment depicted in FIG. 1, the first and second conveying sections 1, 2 are respectively arranged one below the other in a vertical direction. However, this layout is not mandatory and the individual conveying sections 1, 2 can also be arranged in a quasi-vertical direction (not shown) or they can be disposed in a horizontal or quasi-horizontal direction (not shown). In a further embodiment (not shown), the first conveying section for the signatures and the second conveying section for the inserts may extend in opposite directions, at a right angle, or at an inclined angle, relative to each other.

As shown in FIG. 1, the signatures 10 are gathered and conveyed along an upper (first) conveying section 1 and may be combined into individual partial book blocks. The partial book blocks may be subsequently transferred to a first gathering location A which forms a first gathering plane. At least one second conveying section 2 for the inserts 20 thus essentially forms an additional autonomous conveying section which is operatively connected at its end to an additional (second) gathering location B on approximately the same level. This additional gathering location B, in turn, is also operatively connected to the first gathering location A, so that at least one partial book block is formed in the additional gathering location B and which is composed of at least one signature 10 and at least one insert 20. This partial book block is then transferred to another additional (third) gathering location C that preferably forms a separate plane. If the gathering locations A, B, C are respectively arranged one below the other and there are three planes, for example, the last gathering location C forms a third plane. In this third plane, the complete book block 40 itself is produced with the successively conveyed signatures 10 and/or inserts 20. Bypassing the second conveying section 2 that supplies the inserts 20, the signatures 10, or the partial book blocks formed therewith, can also be transferred from the first gathering location A directly to the third gathering location C in order to form a respective complete book block 40. Of course, at certain points inserts 20 supplied by the second conveying section 2 can still be added in this third gathering location C. In addition, this third gathering location C should not be understood to be the final location. If necessary, additional gathering locations (not shown) that complement the stacking of the book blocks can also be provided without problems.

As previously explained, the signatures 10 and the inserts 20 are respectively conveyed along autonomously operating first and second conveying sections 1, 2 for which conveying speeds thereof can be varied as needed. Individual drives (not shown) can be used for this such as, for example, drives embodied as servomotors. The signatures 10 as well as the inserts 20 can be conveyed individually and spaced apart, relative to each other, or in the form of a scaled flow (e.g., overlapping). These conveying options also offer the possibility of coordinating the various cadences and belt speeds, in particular if the folding of these intermediate products should also include the inserts 20.

As shown in the embodiment depicted in FIG. 1, each conveying plane is respectively formed by at least one continuously circulating belt, wherein these belts may be arranged parallel or quasi-parallel to each other, as seen in the vertical direction, so that the signatures 10 and inserts 20 are essentially conveyed further with the aid of a translatory movement along the conveying planes.

The signatures 10 and/or the inserts 20 (e.g., individual sheets) can, for example, also be clamped in to ensure a secure transport, meaning the signatures 10 or inserts 20 may be held in place between an upper belt section (not shown) and the respective conveying belt. The transfer of these partial products to the first gathering location A and to the second gathering location B also occurs with the aid of a translatory, and essentially horizontal, movement. A different translatory movement, relative to the preceding conveying sections 1, 2, can be carried out only during the transfer to the stack-forming gathering location C. If this stack-forming gathering location C is arranged directly below the first and second gathering locations A, B for catching the partial printed products or book blocks, this movement changes to a vertical translatory movement.

The herein described conveying system is particularly suitable for changing or adapting the speeds along the conveying planes, relative to each other, by using adaptive controls with movement profiles.

In principle, the described first and second conveying sections 1, 2 are configured such that the forces generated during a high-speed conveying and subsequent gathering of the signatures 10 and inserts 20 to form partial printed products or book blocks cannot negatively affect the forming of the respective stacks. With respect to the temporary stacking of the folded signatures 10 in an intermediary gathering location or during the final stacking of these signatures 10, it can be said in principle that they have a form stability which ensures that the signatures 10 within the stack remain perpendicular and compact throughout the complete stacking operation. If interfering lateral forces appear during the transport and the subsequent stacking of these deposited signatures 10, these forces cannot weaken the stability of the stack. During the stacking operation, the stack is furthermore jogged, for example with the aid of end stops on the side, in order to align the signatures 10 or inserts 20 precisely against the end stop. If applicable, steps may be required to ensure a secure stacking in cases where the inserts 20 are individual sheets.

The stability of the stack or the cohesion of the signatures 10 and/or the inserts 20 can furthermore be increased through the deliberate use of binding agents, such as adhesive.

Hold-back elements 30 can furthermore be used within the first conveying section 1 to support the partial book block separating operation, wherein these hold-back elements 30 insert gaps into the scaled flow. Hold-back elements 30 of this type, which cause a separation of the conveyed flow, can be embodied as rake-type, intermittently-operating separating elements that engage with precise timing in the scaled flow to briefly delay the effective flow in this first conveying section 1, so that the remaining scaled flow, which continues to be conveyed, can without problem supply the gathering device. This mode of operation is known per se to one skilled in the art of stackers, or so-called cross-stackers, which can operate downstream of a gathering and wire-stitching machine.

A control unit ensures the process-technical safety of the system and controls the drives as well as the separating elements. The partial products are continuously checked for quality and completeness. For example, control systems may be provided which are configured to identify and track the individual signatures 10 and/or inserts 20. The control systems may include additionally arranged sensors connected to the control unit and arranged to monitor at least one of behavior, localization, speed, and composition of the signatures and/or inserts. Each of the individual signatures 10 and/or inserts 20 may include an identification mark such as, for example but not limited to, a barcode or a data matrix arranged to be monitored by the sensors. The control unit may be configured to continuously process monitoring information received from the sensors and trigger appropriate control commands.

The inserts 20 can be inserted between the pages of a book block, or they can be added to the beginning of the book block as the first sheet or signature, or at the end of the book block as the last sheet or signature. The first step therefore need not absolutely be the forming of a partial book block, composed of one or several signatures. The process can start without problem with an insert 20. Of course, the sequence can also be reversed with an insert 20 having been supplied in a different plane to the stack in progress, before a partial book block is added to complete the stack.

It will be understood that the above description of the embodiments of the present invention is susceptible to various modifications, changes and adaptations, and the same are intended to be comprehended within the meaning and range of equivalents of the appended claims.

What is claimed is:

1. A method for producing a printed product, comprising:
conveying signatures along a first conveying section;
conveying inserts along a second conveying section;
supplying the signatures to at least one of a first gathering location and a second gathering location;
supplying the inserts to at least the second gathering location;
forming a partial book block in at least one of the first gathering location and the second gathering location, wherein the partial book block comprises the supplied signatures and, optionally, at least one of the supplied inserts; and
supplying the partial book block to a further gathering location to form a stacked book block.

2. The method according to claim 1, wherein at least one of the first and second conveying sections comprises a separating element arranged to delay and release in a controlled manner a continuously conveyed flow of at least one of the signatures and the inserts.

3. The method according to claim 2, further comprising
utilizing the separating element to stop the continuously conveyed flow along the respective conveying section at a specific location and for a limited time interval.

4. The method according to claim 1, further comprising
controlling conveying speeds of the first and second conveying sections.

5. The method according to claim 1, wherein the first and second conveying sections are arranged vertically or quasi-vertically relative to each other.

6. The method according to claim 1, further comprising
folding at least one of the signatures and the inserts at least once upstream of the first and second conveying sections.

7. The method according to claim 1, wherein the first and second conveying sections each comprise a continuously circulating conveying belt.

8. The method according to claim 1, wherein the first conveying section operates on substantially the same level as the first gathering location.

9. The method according to claim 4, further comprising
changing the conveying speeds along the first and second conveying sections relative to each other with the aid of adaptive controls.

10. The method according to claim 2, further comprising
controlling, with a control unit, conveying speeds for the signatures and the inserts along the first and second conveying sections, respectively; and
intermittently using the separating element, wherein the separating element is controlled by the control unit.

11. The method according to claim 1, wherein at least one of the signatures and the inserts are provided with identification marks, and wherein the method further comprises
monitoring with sensors at least one of behavior, localization, speed, and composition of at least one of the signatures and inserts having the identification marks.

12. The method according to claim 11, wherein the sensors are operatively connected to a control unit, and wherein the method further comprises
continuously processing information received from the sensors; and
triggering control commands with the control unit.

13. The method according to claim 11, wherein the identification marks comprise barcodes or data matrices.

14. The method according to claim 1, wherein the signatures are conveyed along the first conveying section individually or in a scaled flow.

15. The method according to claim 1, wherein the inserts are conveyed along the second conveying section individually or in a scaled flow.

16. The method according to claim 1, wherein the first and second conveying sections are controlled autonomously.

17. The method according to claim 1, wherein the first and second conveying sections are controlled in an operatively coordinated manner.

18. The method according to claim 1, wherein the first and second conveying sections are arranged horizontally or quasi-horizontally relative to each other.

19. The method according to claim 1, wherein the first conveying section for the signatures and the second conveying section for the inserts extend in opposite directions, at a right angle, or at an inclined angle, relative to each other.

20. A system for producing a printed product, comprising:
means for conveying signatures along a first conveying section;
means for conveying inserts along a second conveying section;
means for supplying the signatures to at least one of a first gathering location and a second gathering location;
means for supplying the inserts to at least the second gathering location;
means for forming a partial book block in at least one of the first gathering location and the second gathering location, wherein the partial book block comprises the supplied signatures and, optionally, at least one of the supplied inserts; and
means for supplying the partial book block to a further gathering location to form a stacked book block.

21. A method for producing a complete book block, comprising:
conveying a signature along a first conveying section;
supplying the signature to a first gathering location and, optionally, to a second gathering location;
conveying an insert along a second conveying section;
supplying the insert to the second gathering location when the signature is supplied to the second gathering location;
forming a partial book block in at least one of the first gathering location and the second gathering location, wherein the partial book block comprises the signature in the first gathering location, and wherein the partial book block comprises the signature and the insert in the second gathering location; and
supplying the partial book block from the first gathering location or from the second gathering location to a further gathering location to form the complete book block comprising a plurality of the partial book blocks.
